(19) United States
(12) Patent Application Publication
(10) Pub. No.: US 2022/0011437 A1
(43) Pub. Date: Jan. 13, 2022

(54) DISTANCE MEASURING DEVICE, DISTANCE MEASURING SYSTEM, DISTANCE MEASURING METHOD, AND NON-TRANSITORY STORAGE MEDIUM

(71) Applicant: Panasonic Intellectual Property Management Co., Ltd., Osaka (JP)

(72) Inventors: Shinzo KOYAMA, Osaka (JP); Yutaka HIROSE, Kyoto (JP); Toru OKINO, Osaka (JP); Shigeru SAITOU, Kyoto (JP); Motonori ISHII, Osaka (JP); Akihiro ODAGAWA, Osaka (JP)

(21) Appl. No.: 17/486,863

(22) Filed: Sep. 27, 2021

Related U.S. Application Data
(63) Continuation of application No. PCT/JP2020/007563, filed on Feb. 26, 2020.

(30) Foreign Application Priority Data
Mar. 27, 2019 (JP) 2019-061921

(51) Int. Cl. G01S 17/894; G01S 17/36; G01S 7/4865

(52) U.S. Cl. CPC G01S 17/894; G01S 7/4865; G01S 17/36

(57) ABSTRACT

A distance measuring device includes a control unit and a measuring unit. The control unit controls a photodetector unit. The photodetector unit includes a photoelectric transducer element and an output unit. The photoelectric transducer element generates electrical charges on receiving light reflected from a target as a part of measuring light emitted from a light-emitting unit. The output unit outputs an electrical signal representing a quantity of the electrical charges generated by the photoelectric transducer element. The measuring unit calculates, in accordance with the electrical signal, a distance to the target within a measurable range. The control unit sets, in each of a plurality of intervals that form the measurable range, a conversion ratio of the quantity of the electrical charges generated by the photoelectric transducer element to a quantity of the light received by the photoelectric transducer element.

### CROSS-REFERENCE TO RELATED APPLICATIONS

The present application is a Bypass Continuation of International Application No. PCT/JP2020/007563 filed on Feb. 26, 2020, which is based upon, and claims the benefit of priority to, Japanese Patent Application No. 2019-061921, filed on Mar. 27, 2019. The entire contents of both applications are incorporated herein by reference.

### TECHNICAL FIELD

The present disclosure generally relates to a distance measuring device, a distance measuring system, a distance measuring method, and a non-transitory storage medium. More particularly. the present disclosure relates to a distance measuring device, a distance measuring system, a distance measuring method, and a non-transitory storage medium, all of which are configured or designed to measure the distance to a target.

### BACKGROUND ART

JP 2018-169162 A discloses a distance measuring device. The distance measuring device of JP 2018-169162 A includes a solid-state mage sensor, a signal processor, a computer, and a light source. The solid-state mage sensor includes a plurality of pixels which are arranged two-dimensionally. Each of the pixels includes: a photo-sensing circuit for detecting an incoming light beam that has reached a photosensitive element within a predetermined exposure duration; a counter circuit for counting the number of times that the incoming light beam has reached based on a photo-sensing signal supplied from the photo-sensing circuit; a comparator circuit for outputting a comparison signal based on a count value supplied from the counter circuit; and a storage circuit for storing a time signal as a distance signal when the comparison signal supplied from the comparator circuit is ON.

JP 2018-169162 A states that the measurable distance range may be broadened by the solid-state mage sensor with such a configuration. However, J P 2018-169162 A does not teach how to improve the measurement accuracy over the entire measurable range of the distance to the target.

### SUMMARY

The present disclosure provides a distance measuring device, a distance measuring system, a distance measuring method, and a non-transitory storage medium, all of which are configured or designed to improve the measurement accuracy over the entire measurable range of the distance to the target.

A distance measuring device according to an aspect of the present disclosure includes a control unit and a measuring unit. The control unit controls a photodetector unit. The photodetector unit includes a photoelectric transducer element and an output unit. The photoelectric transducer element generates electrical charges on receiving light reflected from a target as a part of measuring light emitted from a light-emitting unit. The output unit outputs an electrical signal representing a quantity of the electrical charges generated by the photoelectric transducer element. The measuring unit calculates, in accordance with the electrical signal, a distance to the target within a measurable range. The control unit sets, in each of a plurality of intervals that form the measurable range, a conversion ratio of the quantity of the electrical charges generated by the photoelectric transducer element to a quantity of the light received by the photoelectric transducer element.

A distance measuring system according to another aspect of the present disclosure includes the distance measuring device described above, the light-emitting unit, and the photodetector unit.

A distance measuring method according to still another aspect of the present disclosure includes a control step and a measuring step. The control step includes controlling a photodetector unit. The photodetector unit includes a photoelectric transducer element and an output unit. The photoelectric transducer element generates electrical charges on receiving light reflected from a target as a part of measuring light emitted from a light-emitting unit. The output unit outputs an electrical signal representing a quantity of the electrical charges generated by the photoelectric transducer element. The measuring step includes calculating, in accordance with the electrical signal, a distance to the target within a measurable range. The control step includes setting, in each of a plurality of intervals that form the measurable range, a conversion ratio of the quantity of the electrical charges generated by the photoelectric transducer element to a quantity of the light received by the photoelectric transducer element.

A non-transitory storage medium according to yet another aspect of the present disclosure stores thereon a program designed to cause one or more processors to perform the distance measuring method described above.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 is a block diagram of a distance measuring system according to an exemplary embodiment;

FIG. 2 illustrates the distance measuring system;

FIG. 3 is a circuit diagram of a photoelectric transducer element of the distance measuring system;

FIG. 4 schematically illustrates how the distance measuring system operates;

FIG. 5 schematically illustrates how the distance measuring system operates;

FIG. 6 schematically illustrates how the distance measuring system operates;

FIG. 7 illustrates a first method for controlling the distance measuring system;

FIG. 8 illustrates a second method for controlling the distance measuring system; and

FIG. 9 illustrates an exemplary arrangement of a plurality of intervals that form a measurable range according to a variation.

### DETAILED DESCRIPTION

### 1. Embodiment

### 1.1. Overview

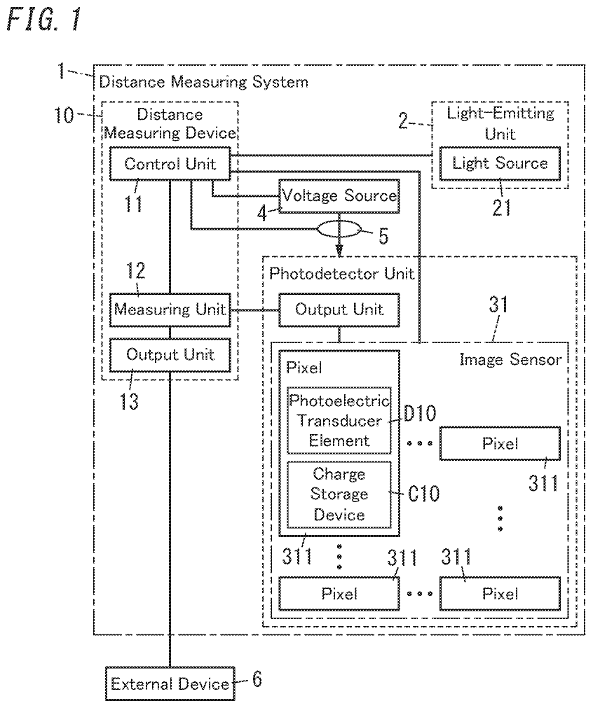

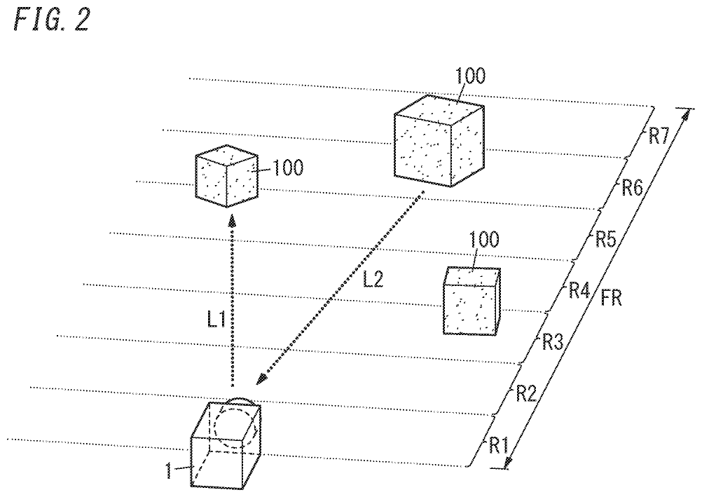

FIG. 1 illustrates a distance measuring system 1 according to an exemplary embodiment. The distance measuring system 1 includes a distance measuring device 10. The distance measuring device 10 includes a control unit 11 and a measuring unit 12. The control unit 11 controls a photodetector unit 3. The photodetector unit 3 includes a photoelectric transducer element D10 and an output unit 32 as shown in FIGS. 1 and 2. The photoelectric transducer element D10 generates electrical charges on receiving light L2 reflected from a target 100 as a part of measuring light L1 emitted from a light-emitting unit 2. The output unit 32 outputs an electrical signal representing a quantity of the electrical charges generated by the photoelectric transducer element D10. The measuring unit 12 calculates, in accordance with the electrical signal, a distance to the target within a measurable range FR. The control unit 11 sets, in each of a plurality of intervals R1-R7 that form the measurable range FR, a ratio of the quantity of the electrical charges generated by the photoelectric transducer element D10 to a quantity of the light received by the photoelectric transducer element D10.

Such a distance measuring device 10 may set the conversion ratio appropriately in each of the plurality of intervals R1-R7 that form the measurable range FR. That is to say, the distance measuring device 10 may set the conversion ratio at an appropriate value according to the location of the target 100. Thus, this distance measuring device 10 contributes to improving the measurement accuracy over the entire measurable range of the distance to the target 100.

### 1.2. Details

The distance measuring system 1 will be described in further detail with reference to FIGS. 1-8. The distance measuring system 1 measures the distance to the target 100 by the time of flight (TOF) technique. The distance measuring system 1 includes a distance measuring device 10, a light-emitting unit 2, a photodetector unit 3, a voltage source 4, and a current measuring unit 5. The distance measuring system 1 measures the distance to the target 100 by using the light (reflected light) L2 reflected from the target 100 as a part of measuring light L1 emitted from the light-emitting unit 2 as shown in FIG. 2. The distance measuring system 1 is applicable for use in, for example, an object recognition system used as a piece of onboard equipment for cars to detect an obstacle, and a surveillance camera and a security camera for detecting an object (that is a human).

The light-emitting unit 2 includes a light source 21 for irradiating the target 100 with the measuring light L1. The measuring light L1 is a pulsed light beam. In FIG. 2, the measuring light L1 is indicated conceptually by a dotted line. With this regard, when the distance is measured by the TOF technique, the measuring light L1 suitably has a single wavelength, a relatively short pulse width, and a relatively high peak intensity. In addition, considering the use of the distance measuring system 1 (distance measuring device 10) in an urban area, for example, the wavelength of the measuring light L1 suitably falls within the near-infrared wavelength range in which the luminosity factor is low to the human eye and which is less susceptible to ambient light coming from the sun. In this embodiment, the light source 21 is implemented as a laser diode, for example, and emits a pulsed laser beam. The intensity of the pulsed laser beam emitted from the light source 21 satisfies Class 1 or Class 2 of “Safety of Laser Products” standard (JIS C 6802) established in the country of Japan. Note that the light source 21 does not have to be a laser diode but may also be a light-emitting diode (LED), a vertical cavity surface emitting laser (VCSEL), or a halogen lamp, for example. Optionally, the measuring light L1 may also fall within a wavelength range different from the near-infrared wavelength range.

The photodetector unit 3 includes a photoelectric transducer element D10 and an output unit 32. The photoelectric transducer element D10 generates electrical charges on receiving the light L2 reflected from the target 100 as a part of the measuring light L1 emitted from the light-emitting unit 2. The output unit 32 outputs an electrical signal (pixel signal) representing the quantity of the electrical charges generated by the photoelectric transducer element D10. In this embodiment, the photodetector unit 3 includes an image sensor 31 and the output unit 32. The image sensor 31 includes a plurality of pixels 311 which are arranged two-dimensionally as shown in FIG. 1. Each of the plurality of pixels 311 may receive the light only during an exposure duration. The output unit 32 outputs an electrical signal supplied from (the pixels 311 of) the image sensor 31 to the distance measuring device 10.

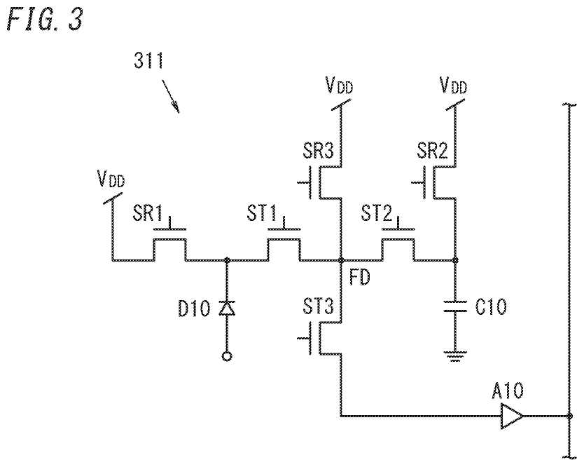

FIG. 3 is a circuit diagram of each pixel 311. As shown in FIG. 3, the pixel 311 includes the photoelectric transducer element D10, a charge storage device C10, a floating diffusion element FD, an amplifier A10, transfer transistors ST1, ST2, ST3, and reset transistors SR1, SR2, SR3.

The photoelectric transducer element D10 generates electrical charges on receiving the light L2 reflected from the target 100 as a part of the measuring light L1 emitted from the light-emitting unit 2. The photoelectric transducer element D10 is configured to vary the conversion ratio according to the voltage applied (to the photoelectric transducer element D10 itself). As used herein, the conversion ratio refers to the ratio of the quantity of the electrical charges generated by the photoelectric transducer element D10 to the quantity of the light (i.e., the number of photons) received by the photoelectric transducer element D10. For example, the conversion ratio of the photoelectric transducer element D10 is variable within a range that is equal to or greater than 1. In this embodiment, the photoelectric transducer element D10 is implemented as an avalanche photodiode. The avalanche photodiode has a linear multiplication mode and a Geiger multiplication mode. The avalanche photodiode operates in the linear multiplication mode when a first bias (of −25 V, for example) is applied thereto. In the linear multiplication mode, when photons are incident on the avalanche photodiode, a quantity of electrical charges, generally proportional to the number of the photons that cause photoelectric conversion, are collected in its cathode. On the other hand, when a second bias (of −27 V, for example), of which the absolute value is greater than that of the first bias, is applied thereto, the avalanche photodiode operates in the Geiger multiplication mode. In the Geiger multiplication mode, when one of the photons incident on the avalanche photodiode causes photoelectric conversion, a saturated quantity of electrical charges (i.e., a quantity of saturated electrical charges) are collected in its cathode. That is to say, the quantity of the electrical charges generated in response to the incidence of one photon becomes constant. As can be seen, the multiplication factor of the avalanche photodiode varies according to the magnitude of the bias, i.e., the magnitude of the voltage (a reverse voltage) applied to the avalanche photodiode. In this embodiment, the conversion ratio of the photoelectric transducer element D10 is the multiplication factor of the avalanche photodiode.

The charge storage device C10 stores at least some of the electrical charges generated by the photoelectric transducer element D10. The charge storage device C10 is a capacitor. The charge storage device C10 has its capacitance set at such a value that allows the electrical charges generated by the photoelectric transducer element D10 to be stored multiple times. That is to say, the charge storage device C10 allows the electrical charges generated by the photoelectric transducer element D10 to be accumulated, thereby contributing to increasing the SNR of an electrical signal as an output signal of the image sensor 31 and eventually improving the measurement accuracy. In this embodiment, a first terminal of the charge storage device C10 is grounded.

The floating diffusion element FD is provided between the photoelectric transducer element D10 and the charge storage device C10 and is used to store the electrical charges. The amplifier A10 outputs, to the output unit 32, an electrical signal (pixel signal), of which the magnitude corresponds to the quantity of the electrical charges generated by the photoelectric transducer element D10 (i.e., the magnitude corresponding to the quantity of the electrical charges stored in the charge storage device C10). The transistor ST1 connects the cathode of the photoelectric transducer element D10 to the floating diffusion element FD. The transistor ST2 connects the floating diffusion element FD to a second terminal of the charge storage device C10. The transistor ST3 connects the floating diffusion element FD to an input terminal of the amplifier A10. The transistor SR1 connects the cathode of the photoelectric transducer element D10 to an internal power supply VDD. The transistor SR2 connects the second terminal of the charge storage device C10 to the internal power supply VDD. The transistor SR3 connects the floating diffusion element FD to the internal power supply VDD.

In the pixel 311, the electrical charges generated by the photoelectric transducer element D10 are transferred to, and stored in, the charge storage device C10 by the transistors ST1, ST2. After the electrical charges generated by the photoelectric transducer element D10 have been stored in the charge storage device C10 multiple times, the electrical charges are transferred by the transistor ST3 from the charge storage device C10 to the amplifier A10. This causes the amplifier A10 to output an electrical signal (pixel signal), of which the magnitude corresponds to the quantity of the electrical charges generated by the photoelectric transducer element D10 (i.e., the magnitude corresponds to the quantity of the electrical charges stored in the charge storage device C10). Thereafter, unnecessary electrical charges left in the photoelectric transducer element D10, the floating diffusion element FD and the charge storage device C10 are removed appropriately by the transistors SR1, SR2, SR3. Such control of the pixel 311 is performed by the control unit 11.

The voltage source 4 applies a DC control voltage to the photodetector unit 3. The magnitude of the control voltage applied by the voltage source 4 may be changed. In this embodiment, the voltage source 4 is electrically connected to the anode of the photoelectric transducer element D10 in each of the plurality of pixels 311 of the image sensor 31 of the photodetector unit 3. This allows the voltage source 4 to apply a control voltage to the photoelectric transducer element D10 in each of the plurality of pixels 311 of the image sensor 31 of the photodetector unit 3. In particular, the voltage source 4 may be used to apply, to the photoelectric transducer element D10, a reverse voltage (reverse bias) as the control voltage. That is to say, the operation mode of the photoelectric transducer element D10 may be switched by the voltage source 4 from the linear multiplication mode to the Geiger multiplication mode, or vice versa. The voltage source 4 is controlled by the control unit 11. This allows the control unit 11 to make the voltage source 4 switch the operation mode of the photoelectric transducer element D10. Note that the voltage source 4 may be implemented as a known power supply such as a switching power supply, and therefore, detailed description thereof will be omitted herein.

The current measuring unit 5 measures the magnitude of an electric current flowing from the voltage source 4 to the photodetector unit 3. The current measuring unit 5 gives a value thus measured to the control unit 11. The current measuring unit 5 may be implemented as a known current measuring instrument (ammeter) such as a current transformer, and therefore, detailed description thereof will be omitted herein.

The distance measuring device 10 calculates the distance to the target 100 within the measurable range FR. In the distance measuring device 10, the measurable range FR is divided into plurality of (e.g., seven) intervals R1-R7 as shown in FIG. 2. In other words, the measurable range FR is made up of the plurality of intervals R1-R7. The measurable range FR may, but does not have to, have a length of a few ten centimeters to several ten meters, for example. The plurality of intervals R1-R7 each have the same length. For example, each of the plurality of intervals R1-R7 may have a length of a few centimeters to several meters. Note that the plurality of intervals R1-R7 do not have to have the same length and the number of the intervals provided is not limited to any particular one.

The distance measuring device 10 includes the control unit 11, the measuring unit 12, and an output unit 13. Note that each of the control unit 11 and the measuring unit 12 may be implemented as a computer system including one or more processors (microprocessors) and one or more memories. That is to say, the computer system performs the functions of the control unit 11 and the measuring unit 12 by making the one or more processors execute one or more programs (applications) stored in the one or more memories. In this embodiment, the program is stored in advance in the one or more memories. However, this is only an example and should not be construed as limiting. The program may also be downloaded via a telecommunications line such as the Internet or distributed after having been stored in a non-transitory storage medium such as a memory card.

The control unit 11 is configured to control the light-emitting unit 2 and the photodetector unit 3. As for the light-emitting unit 2, the control unit 11 controls, for example, the timing for the light source 21 to emit the measuring light L1 (i.e., a light emission timing) and the pulse width of the measuring light L1 emitted from the light source 21. As for the photodetector unit 3, on the other hand, the control unit 11 controls, for example, the timing to turn each pixel 311 (the photoelectric transducer element D10) into an exposure state (i.e., exposure timing), an exposure duration (exposure period), and the operation timings of the respective transistors ST1-ST3.

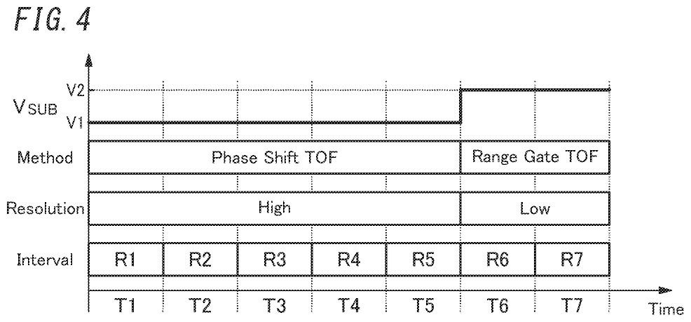

Furthermore, the control unit 11 is also configured to control the conversion ratio of each photoelectric transducer element D10. In particular, the control unit 11 controls the conversion ratio of the photoelectric transducer element D10 in each of a plurality of intervals R1-R7 that form the measurable range FR. Since this distance measuring device 10 uses the TOF technique, the plurality of intervals R1-R7 of the distance correspond to a plurality of periods T1-T7, respectively, as shown in FIG. 4. Therefore, the control unit 11 sets the conversion ratio by the voltage applied to the photoelectric transducer element D10 in each of the plurality of periods T1-T7 corresponding to the plurality of intervals R1-R7, respectively. That is to say, the control unit 11 sets the conversion ratio of the photoelectric transducer element D10 by setting the control voltage to be applied by the voltage source 4 to the photoelectric transducer element D10 in each of the plurality of intervals R1-R7 (corresponding to the plurality of periods T1-T7). In this embodiment, the conversion ratio of the photoelectric transducer element D10 is the multiplication factor of the avalanche photodiode. The control unit 11 sets the multiplication factor of the avalanche photodiode at either a multiplication factor for the linear multiplication mode or a multiplication factor for the Geiger multiplication mode. In FIG. 4, VSUB denotes a control voltage applied by the voltage source 4 to the photoelectric transducer element D10. V1 denotes a first bias (i.e., a voltage that switches the photoelectric transducer element D10 into the linear multiplication mode). V2 denotes a second bias (i.e., a voltage that switches the photoelectric transducer element D10 into the Geiger multiplication mode).

As described above, in the linear multiplication mode, the quantity of the electrical charges generated by the photoelectric transducer element D10 is generally proportional to the number of photons incident on the photoelectric transducer element D10. In the Geiger multiplication mode, on the other hand, the quantity of the electrical charges generated by the photoelectric transducer element D10 is constant, irrespective of the number of photons incident on the photoelectric transducer element D10. Therefore, the distance to the target 100 may have a higher resolution when the photoelectric transducer element D10 is switched to the linear multiplication mode than when the photoelectric transducer element D10 is switched to the Geiger multiplication mode. On the other hand, a greater quantity of electrical charges are generated by the photoelectric transducer element D10 in response to the incidence of the photons in the Geiger multiplication mode than in the linear multiplication mode. Therefore, if a relatively large number of photons are incident on the photoelectric transducer element D10 (i.e., if the photoelectric transducer element D10 receives a relatively large quantity of light), then the photoelectric transducer element D10 suitably operates in the linear multiplication mode. On the other hand, if a relatively small number of photons are incident on the photoelectric transducer element D10 (i.e., if the photoelectric transducer element D10 receives a relatively small quantity of light), then the photoelectric transducer element D10 suitably operates in the Geiger multiplication mode. The light received by the photoelectric transducer element D10 includes the light L2 reflected from the target 100 and ambient light (mainly the light coming from the environment surrounding the photodetector unit 3). The quantity of the light received by the photoelectric transducer element D10 varies according to the duration during which the photoelectric transducer element D10 may receive light from the target 100 (i.e., the exposure duration). In addition, the quantity of the light L2 reflected from the target 100 is also affected by the distance to the target 100 and the surface conditions of the target 100. Examples of the surface conditions of the target 100 include the (surface) reflectance of the target 100.

In this embodiment, the control unit 11 sets the conversion ratio based on various factors including the estimated distance to the target 100, the quantity of the ambient light, the exposure duration, and the quantity of the light received by the photoelectric transducer element D10 from the target 100. In this case, the control unit 11 decreases the conversion ratio when the resolution of the distance to the target 100 needs to be increased (in the linear multiplication mode) and increases the conversion ratio when the resolution needs to be decreased (in the Geiger multiplication mode).

The control unit 11 classifies the plurality of intervals R1-R7 into a first interval and a second interval corresponding to a longer distance from the photoelectric transducer element D10 (i.e., from the distance measuring system 1) than in the first interval. The control unit 11 decreases the conversion ratio in the first interval and increases the conversion ratio in the second interval. In this embodiment, the control unit 11 makes the photoelectric transducer element D10 operate in the linear multiplication mode in the first interval and makes the photoelectric transducer element D10 operate in the Geiger multiplication mode in the second interval. For example, in the example illustrated in FIG. 4, the control unit 11 regards the intervals R1-R5 as the first interval and the intervals R6, R7 as the second interval. In this case, the control unit 11 makes the photoelectric transducer element D10 operate in the linear multiplication mode by setting the control voltage VSUB of the voltage source 4 at V1 during the periods T1-T5 corresponding to the intervals R1-R5, respectively. On the other hand, the control unit 11 makes the photoelectric transducer element D10 operate in the Geiger multiplication mode by setting the control voltage VSUB of the voltage source 4 at V2 during the periods T6, T7 corresponding to the intervals R6, R7, respectively.

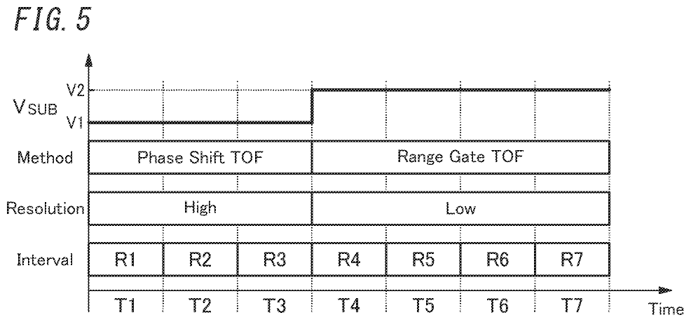

In addition, the control unit 11 also changes the conversion ratio according to the quantity of the ambient light. More specifically, the control unit 11 decreases the conversion ratio if the quantity of the ambient light is large and increases the conversion ratio if the quantity of the ambient light is small. In this embodiment, the control unit 11 compares the quantity of the ambient light with a threshold value in each of the plurality of intervals R1-R7. The control unit 11 makes the photoelectric transducer element D10 operate in the Geiger multiplication mode when finding the quantity of the ambient light equal to or less than the threshold value and makes the photoelectric transducer element D10 operate in the linear multiplication mode when finding the quantity of the ambient light greater than the threshold value. For example, suppose the quantity of the ambient light is greater than the threshold value in the intervals R1-R5 and is equal to or less than the threshold value in the intervals R6, R7. In that case, as shown in FIG. 4, the control unit 11 makes the photoelectric transducer element D10 operate in the linear multiplication mode by setting the control voltage VSUB of the voltage source 4 at V1 during the periods T1-T5 corresponding to the intervals R1-R5, respectively. On the other hand, the control unit 11 makes the photoelectric transducer element D10 operate in the Geiger multiplication mode by setting the control voltage VSUB of the voltage source 4 at V2 during the periods T6, T7 corresponding to the intervals R6, R7, respectively. Suppose the quantity of the ambient light has decreased to be equal to or less than the threshold value in the interval R4. In that case, the control unit 11 makes the photoelectric transducer element D10 operate in the linear multiplication mode by setting the control voltage VSUB of the voltage source 4 at V1 during the periods T1-T3 corresponding to the intervals R1-R3, respectively, as shown in FIG. 5. On the other hand, the control unit 11 makes the photoelectric transducer element D10 operate in the Geiger multiplication mode by setting the control voltage VSUB of the voltage source 4 at V2 during the periods T4-T7 corresponding to the intervals R4-R7.

Furthermore, the control unit 11 also changes the conversion ratio according to the length of the exposure duration. More specifically, the control unit 11 decreases the conversion ratio if the exposure duration is long and increases the conversion ratio if the exposure duration is short. In this embodiment, the control unit 11 compares the length of the exposure duration with a threshold value in each of the plurality of intervals R1-R7. The control unit 11 makes the photoelectric transducer element D10 operate in the Geiger multiplication mode when finding the length of the exposure duration equal to or less than the threshold value and makes the photoelectric transducer element D10 operate in the linear multiplication mode when finding the length of the exposure duration greater than the threshold value.

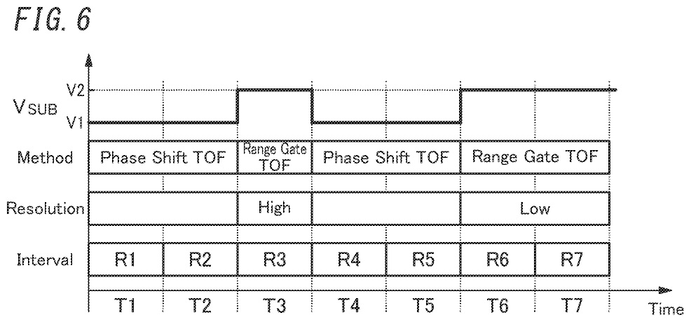

Furthermore, the control unit 11 also changes the conversion ratio according to the quantity of the light received by the photoelectric transducer element D10 from the target 100 (i.e., the quantity of the light L2 reflected from the target 100). More specifically, the control unit 11 decreases the conversion ratio if the quantity of the light L2 is large and increases the conversion ratio if the quantity of the light L2 is small. In this embodiment, the control unit 11 compares the quantity of the light L2 with a threshold value in each of the plurality of intervals R1-R7. The control unit 11 may set the conversion ratio of the photoelectric transducer element D10 at a first value when finding the quantity of the light L2 equal to or less than the threshold value and set the conversion ratio of the photoelectric transducer element D10 at a second value, which is larger than the first value, when finding the quantity of the light L2 greater than the threshold value. In this case, the first value is a conversion ratio corresponding to the linear multiplication mode of the photoelectric transducer element D10 and the second value is a conversion ratio corresponding to the Geiger multiplication mode of the photoelectric transducer element D10. For example, suppose the quantity of the light L2 is greater than the threshold value in the intervals R1-R5. In that case, as shown in FIG. 4, the control unit 11 makes the photoelectric transducer element D10 operate in the linear multiplication mode by setting the control voltage VSUB of the voltage source 4 at V1 during the periods T1-T5 corresponding to the intervals R1-R5, respectively. Also, suppose the quantity of the light L2 has decreased to be equal to or less than the threshold value in the interval R3. In that case, the control unit 11 makes the photoelectric transducer element D10 operate in the Geiger multiplication mode by setting the control voltage VSUB of the voltage source 4 at V2 during the period T3 corresponding to the interval R3 as shown in FIG. 6.

Furthermore, the control unit 11 changes the conversion ratio according to the amount of an electric current flowing through the photoelectric transducer element D10. More specifically, the control unit 11 changes the conversion ratio of the photoelectric transducer element D10 according to the measured value obtained by the current measuring unit 5. That is to say, the control unit 11 switches the operation mode of the photoelectric transducer element D10 from the linear multiplication mode to the Geiger multiplication mode, or vice versa, according to the measured value obtained by the current measuring unit 5. Specifically, the control unit 11 switches, when finding the measured value obtained by the current measuring unit 5 equal to or less than a first threshold value while the photoelectric transducer element D10 is operating in the linear multiplication mode, the photoelectric transducer element D10 to the Geiger multiplication mode. On the other hand, the control unit 11 switches, when finding the measured value obtained by the current measuring unit 5 greater than a second threshold value while the photoelectric transducer element D10 is operating in the Geiger multiplication mode, the photoelectric transducer element D10 to the linear multiplication mode. That is to say, when the amount of electric current flowing through the photoelectric transducer element D10 is small, the quantity of the electrical charges generated by the photoelectric transducer element D10 would be small, and therefore, the quantity of the light incident on the photoelectric transducer element D10 should be small. Thus, the control unit 11 switches the photoelectric transducer element D10 to the Geiger multiplication mode, instead of the linear multiplication mode. Conversely, when the amount of electric current flowing through the photoelectric transducer element D10 is large, the quantity of the electrical charges generated by the photoelectric transducer element D10 would be large, and therefore, the quantity of the light incident on the photoelectric transducer element D10 should be large. Thus, the control unit 11 switches the photoelectric transducer element D10 to the linear multiplication mode, instead of the Geiger multiplication mode. In this case, the first threshold value and the second threshold value may be the same value or mutually different values, whichever is appropriate.

In addition, the control unit 11 controls the light-emitting unit 2 and the photodetector unit 3 differently depending on whether the photoelectric transducer element D10 is operating in the linear multiplication mode or the Geiger multiplication mode. More specifically, if the photoelectric transducer element D10 is operating in the linear multiplication mode, the control unit 11 performs a first control method. On the other hand, if the photoelectric transducer element D10 is operating in the Geiger multiplication mode, the control unit 11 performs a second control method. That is to say, the first control method is applicable to a situation where the resolution is high (i.e., a situation where a quantity of the light received by the photoelectric transducer element D10 is relatively large). On the other hand, the second control method is applicable to a situation where the resolution is low (i.e., a situation where a quantity of the light received by the photoelectric transducer element D10 is relatively small).

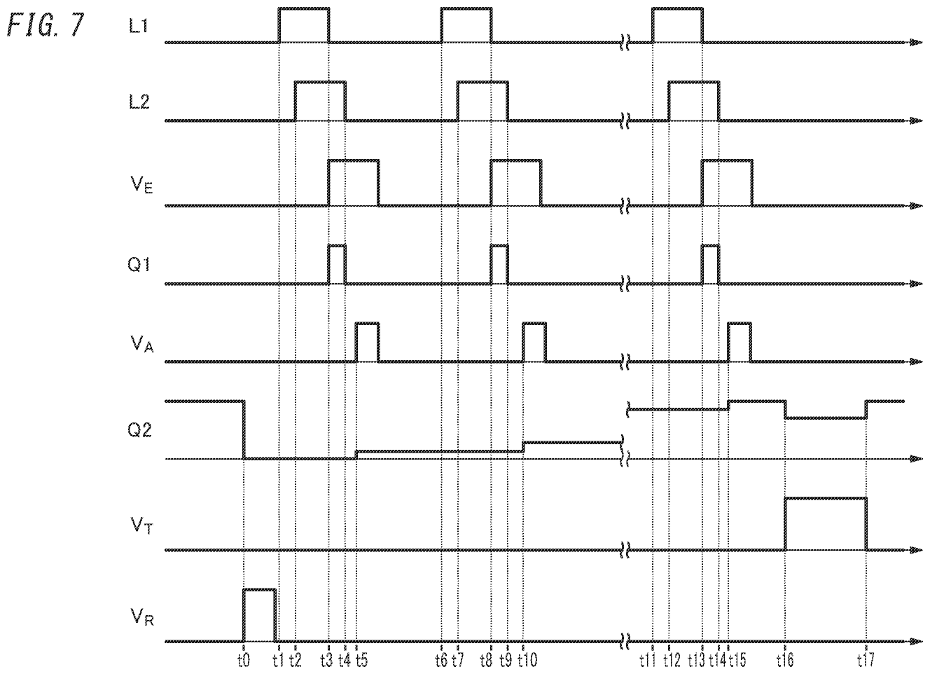

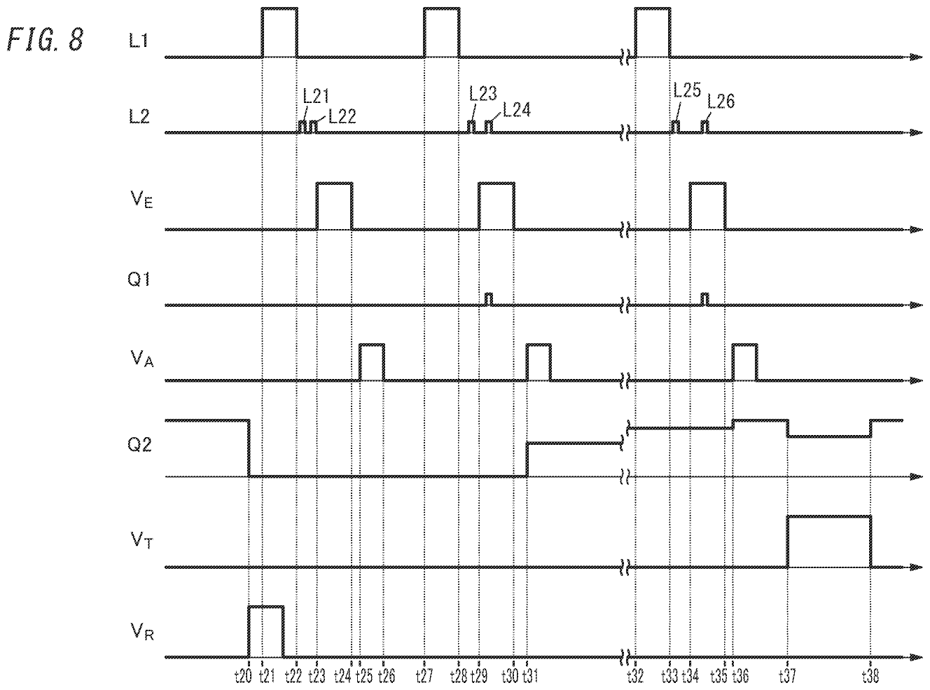

FIG. 7 illustrates how to perform the first method, and FIG. 8 illustrates how to perform the second method. In FIGS. 7 and 8, VE indicates an exposure timing. Q1 denotes the quantity of the electrical charges generated by the photoelectric transducer element D10. VA indicates operation timings for the transistors ST1, ST2. Q2 denotes the quantity of the electrical charges stored in the charge storage device C10. VT indicates an operation timing for the transistor ST3. VR indicates an operation timing for the transistors SR1-SR3.

First, the first control method will be described with reference to FIG. 7. In this example, the transistors ST1-ST3 and SR1-SR3 are supposed to be all OFF before a time t0.

At the time t0, the control unit 11 turns the transistors SR1-SR3 ON to remove the electrical charges from the charge storage device C10. Next, in a period from a time t1 to a time t3, the control unit 11 makes the light source 21 of the light-emitting unit 2 emit the measuring light L1. Thus, in a period from a time t2 to a time t4, the photoelectric transducer element D10 of the photodetector unit 3 receives the light L2 reflected from the target 100. Nevertheless, since the control unit 11 sets the exposure duration from a time t3 and on, the photoelectric transducer element D10 receives the light L2 and generates electrical charges corresponding to the quantity of the light L2 in a period from the time t3 to the time t4. Next, at a time t5 following the time t4, the control unit 11 turns the transistors ST1, ST2 ON to transfer the electrical charges, generated by the photoelectric transducer element D10, to the charge storage device C10 through the floating diffusion element FD.

Thereafter, in a period from a time t6 to a time t8, the control unit 11 makes the light source 21 of the light-emitting unit 2 emit the measuring light L1. Thus, in a period from a time t7 to a time t9, the photoelectric transducer element D10 of the photodetector unit 3 receives the light L2 reflected from the target 100. Nevertheless, since the control unit 11 sets the exposure duration from the time t8 and on, the photoelectric transducer element D10 receives the light L2 and generates electrical charges corresponding to the quantity of the light L2 in a period from the time t8 to a time t9. Next, at a time t10 following the time t9, the control unit 11 turns the transistors ST1, ST2 ON to transfer the electrical charges, generated by the photoelectric transducer element D10, to the charge storage device C10 through the floating diffusion element FD.

The control unit 11 repeats, a predetermined number of times, this processing of transferring the electrical charges, generated by the photoelectric transducer element D10, to the charge storage device C10. When performing this processing for the last time, the control unit 11 makes the light source 21 of the light-emitting unit 2 emit the measuring light L1 in a period from a time t11 to a time t13. Thus, in a period from a time t12 to a time t14, the photoelectric transducer element D10 of the photodetector unit 3 receives the light L2 reflected from the target 100. Nevertheless, since the control unit 11 sets the exposure duration from the time t13 and on, the photoelectric transducer element D10 receives the light L2 and generates electrical charges corresponding to the quantity of the light L2 in the period from the time t13 to the time t14. Next, at a time t15 following the time t14, the control unit 11 turns the transistors ST1, ST2 ON to transfer the electrical charges, generated by the photoelectric transducer element D10, to the charge storage device C10 through the floating diffusion element FD. Thereafter, the control unit 11 extracts the electrical charges stored in the charge storage device C10 by keeping the transistor ST3 ON during a period from a time t16 to a time t17. Thus, the control unit 11 has an electrical signal (pixel signal) output from the pixel 311.

Next, the second control method will be described with reference to FIG. 8. In this example, the transistors ST1-ST3 and SR1-SR3 are supposed to be all OFF before a time t20.

At the time t0, the control unit 11 turns the transistors SR1-SR3 ON to remove the electrical charges from the charge storage device C10. Next, in a period from a time t21 to a time t22, the control unit 11 makes the light source 21 of the light-emitting unit 2 emit the measuring light L1. Thus, the photoelectric transducer element D10 of the photodetector unit 3 receives light beams L21, L22 as the light L2 reflected from the target 100. The light beams L21, L22 come from a target 100 located relatively distant from the distance measuring system 1. The light beams L21, L22 reach the photoelectric transducer element D10 during a period from a time t22 to a time t23. Nevertheless, since the control unit 11 sets the exposure duration from the time t23 and on, the photoelectric transducer element D10 has not generated electrical charges corresponding to the quantity of the light beam L2 yet. Next, in a period from a time t25 to a time t26 following the time t24, the control unit 11 turns the transistors ST1, ST2 ON to transfer the electrical charges, generated by the photoelectric transducer element D10, to the charge storage device C10 via the floating diffusion element FD. In this case, the photoelectric transducer element D10 has generated no electrical charges, and therefore, no electrical charges are stored in the charge storage device C10.

Thereafter, in a period from a time t27 to a time t28, the control unit 11 makes the light source 21 of the light-emitting unit 2 emit the measuring light L1. Thus, the photoelectric transducer element D10 of the photodetector unit 3 receives light beams L23, L24 as the light L2 reflected from the target 100. The light beams L23, L24, as well as the light beams L21, L22, come from a target 100 located relatively distant from the distance measuring system 1. The light beam L23 reaches the photoelectric transducer element D10 during a period from a time t28 to a time t29. On the other hand, the light beam L24 reaches the photoelectric transducer element D10 during a period from a time t29 to a time t30. Nevertheless, since the control unit 11 sets the exposure duration from the time t29 and on, the photoelectric transducer element D10 does not generate electrical charges corresponding to the quantity of the light beam L23 but generates electrical charges corresponding to the quantity of the light beam L24. Next, at a time t31 following the time t30, the control unit 11 turns the transistors ST1, ST2 ON to transfer the electrical charges, generated by the photoelectric transducer element D10, to the charge storage device C10 via the floating diffusion element FD.

The control unit 11 repeats, a predetermined number of times, this processing of transferring the electrical charges, generated by the photoelectric transducer element D10, to the charge storage device C10. When performing this processing for the last time, the control unit 11 makes the light source 21 of the light-emitting unit 2 emit the measuring light L1 in a period from a time t32 to a time t33. Thus, the photoelectric transducer element D10 of the photodetector unit 3 receives light beams L25, L26 as the light L2 reflected from the target 100. The light beams L25, L26, as well as the light beams L21, L22, come from a target 100 located relatively distant from the distance measuring system 1. The light beam L25 reaches the photoelectric transducer element D10 during a period from a time t33 to a time t34. On the other hand, the light beam L26 reaches the photoelectric transducer element D10 during a period from a time t34 to a time t35. Nevertheless, since the control unit 11 sets the exposure duration from the time t34 and on, the photoelectric transducer element D10 does not generate electrical charges corresponding to the quantity of the light beam L25 but generates electrical charges corresponding to the quantity of the light beam L26. Next, at a time t36 following the time t35, the control unit 11 turns the transistors ST1, ST2 ON to transfer the electrical charges, generated by the photoelectric transducer element D10, to the charge storage device C10 via the floating diffusion element FD. Thereafter, the control unit 11 extracts the electrical charges stored in the charge storage device C10 by keeping the transistor ST3 ON during a period from a time t37 through a time t38. Thus, the control unit 11 has an electrical signal (pixel signal) output from the pixel 311.

As can be seen, the control unit 11 sets the conversion ratio (in this embodiment, from the linear multiplication mode to the Geiger multiplication mode) appropriately in each of the plurality of intervals R1-R7 that form the measurable range FR. Then, the control unit 11 controls, based on the conversion ratio thus set, the light-emitting unit 2 and the photodetector unit 3 to have an electrical signal (pixel signal) output from the photodetector unit 3 to the measuring unit 12.

The measuring unit 12 calculates, based on the electrical signal (pixel signal) supplied from the photodetector unit 3, the distance to the target 100 within the measurable range FR. The measuring unit 12 calculates the distance to the target 100 for each of the plurality of pixels 311 (photoelectric transducer elements D10) of the image sensor 31 of the photodetector unit 3. In this embodiment, the measuring unit 12 calculates the distance to the target 100 by two methods. The two methods are two different types of TOF techniques. A first method is a phase shift TOF, while a second method is a range gate TOF. The phase shift TOF enables the distance to be calculated on the order of centimeters. On the other hand, the range gate TOF enables the distance to be calculated on the order of meters but allows calculating a longer distance than the phase shift TOF does. The measuring unit 12 calculates, as for a first group of the plurality of intervals R1-R7, the distance to the target 100 by the phase shift TOF method. The measuring unit 12 calculates, as for a second group of the plurality of intervals R1-R7 on the other hand, the distance to the target 100 by the range gate TOF method. In this case, the first group includes a series of intervals out of the plurality of intervals R1-R7, while the second group includes one or more intervals, which are different from the first group out of the plurality of intervals R1-R7. Each of the intervals included in the first group has a smaller conversion ratio than the second group. That is to say, in this embodiment, each of the intervals included in the first group (i.e., an interval to which the phase shift TOF is applied) is an interval in which the photoelectric transducer element D10 is switched to the linear multiplication mode (i.e., an interval in which a high resolution is set) as shown in FIGS. 4-6. On the other hand, each of the intervals included in the second group (i.e., an interval to which the range gate TOF is applied) is an interval in which the photoelectric transducer element D10 is switched to the Geiger multiplication mode (i.e., an interval in which a low resolution is set).

The measuring unit 12 obtains, where the phase shift TOF is applied (i.e., as for the first group), the distance based on the ratio of electrical signals respectively corresponding to multiple adjacent ones out of the series of intervals included in the first group. More specifically, the measuring unit 12 extracts, from a series of intervals included in the first group, a combination of adjacent intervals in which the sum of the magnitudes of electrical signals is greater than a threshold value and becomes maximum. The distance D to the target 100 is given by D=k×Sk+1/(Sk+Sk+1), where Sk and Sk+1 are the magnitudes of the electrical signals in the combination of intervals extracted. Note that k is a factor of proportionality, which may be set appropriately. On the other hand, the measuring unit 12 obtains, where the range gate TOF is applied (i.e., as for the second group), the distance based on an interval, in which the magnitude of the electrical signal is the largest, out of one or more intervals included in the second group. More specifically, the distance to the interval in which the magnitude of the electrical signal is the largest is used as the distance to the target 100. The measuring unit 12 adopts, as the distance to the target 100, the longer distance selected from the group consisting of the distance determined with respect to the first group and the distance determined with respect to the second group.

Taking the example illustrated in FIG. 4, for instance, the first group includes intervals R1-R5 and the second group includes intervals R6, R7. Suppose the magnitudes of electrical signals respectively corresponding to the intervals R1-R7 are designated by S1-S7, respectively. According to the phase shift TOF, the measuring unit 12 obtains the sum of the magnitudes (S1+S2) of electrical signals in two adjacent intervals R1, R2, the sum of the magnitudes (S2+S3) of electrical signals in two adjacent intervals R2, R3, and the sum of the magnitudes (S3+S4) of electrical signals in two adjacent intervals R3, R4. In this case, the sum of the magnitudes (S2+S3) of electrical signals in two adjacent intervals R2, R3 is supposed to be equal to or greater than a threshold value and larger than any other one of these sums. In that case, the distance D to the target 100 is given by D=k×S3/(S2+S3). According to the range gate TOF on the other hand, the distance is obtained based on an electrical signal of the largest magnitude, among the electrical signals corresponding to the intervals R1-R7, respectively. In this case, if S6 is larger than S5 or S7, then the distance to the interval R6 is used as the distance to the target 100. If the distance determined with respect to the first group is longer than the distance determined with respect to the second group, then the control unit 11 adopts the distance determined with respect to the first group as the distance to the target 100.

The output unit 13 is configured to output, to an external device 6, the calculation result (result of measurement) of the distance to the target 100 obtained by the measuring unit 12. The external device 6 may be a display device such as a liquid crystal display or an organic electroluminescent (EL) display. The output unit 13 outputs the result of measurement obtained by the measuring unit 12 to the external device 6 to have the external device 6 display the result of measurement obtained by the measuring unit 12. In addition, the output unit 13 may also output the image data generated based on the pixel signal to the external device 6 to have the external device 6 display the image data. Note that the external device 6 does not have to be a display device but may also be any other type of device.

### 1.3. Recapitulation

As can be seen from the foregoing description, a distance measuring device 10 includes a control unit 11 and a measuring unit 12. The control unit 11 controls a photodetector unit 3. The photodetector unit 3 includes a photoelectric transducer element D10 and an output unit 32 as shown in FIGS. 1 and 2. The photoelectric transducer element D10 generates electrical charges on receiving light L2 reflected from a target 100 as a part of measuring light L1 emitted from a light-emitting unit 2. The output unit 32 outputs an electrical signal representing a quantity of the electrical charges generated by the photoelectric transducer element D10. The measuring unit 12 calculates, in accordance with the electrical signal, a distance to the target within a measurable range FR. The control unit 11 sets, in each of a plurality of intervals R1-R7 that form the measurable range FR, a conversion ratio of the quantity of the electrical charges generated by the photoelectric transducer element D10 to a quantity of the light received by the photoelectric transducer element D10. Thus, the distance measuring device 10 contributes to improving the measurement accuracy of the distance to the target 100.

In other words, it can be said that the distance measuring device 10 performs the following method (distance measuring method). The distance measuring method includes a control step and a measuring step. The control step includes controlling a photodetector unit 3. The photodetector unit 3 includes a photoelectric transducer element D10 and an output unit 32. The photoelectric transducer element D10 generates electrical charges on receiving light L2 reflected from a target 100 as a part of measuring light L1 emitted from a light-emitting unit 2. The output unit 32 outputs an electrical signal representing a quantity of the electrical charges generated by the photoelectric transducer element D10. The measuring step includes calculating, in accordance with the electrical signal, a distance to the target 100 within a measurable range FR. The control step includes setting, in each of a plurality of intervals R1-R7 that form the measurable range FR, a conversion ratio of the quantity of the electrical charges generated by the photoelectric transducer element D10 to a quantity of the light received by the photoelectric transducer element D10. This distance measuring method, as well as the distance measuring device 10, contributes to improving the measurement accuracy of the distance to the target 100.

The distance measuring device 10 is implemented as a computer system (including one or more processors). That is to say, the functions of the distance measuring device 10 are performed by making one or more processors execute a program (computer program). The program is designed to make the one or more processors perform the distance measuring method. Such a program contributes, as well as the distance measuring method, to improving the measurement accuracy of the distance to the target 100.

### 2. Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Next, variations of the exemplary embodiment will be enumerated one after another.

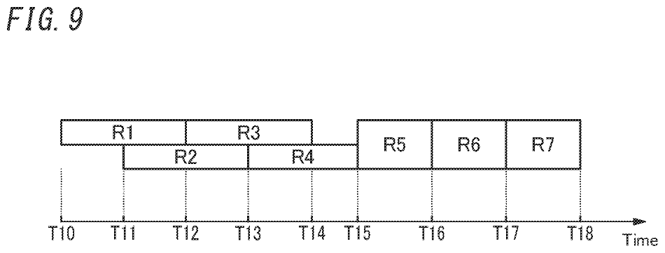

In the embodiment described above, the measurable range FR is made up of a plurality of intervals R1-R7 that do not overlap with each other. Alternatively, the measurable range FR may also be made up of a plurality of intervals R1-R7 shown in FIG. 9. Specifically, the interval R1 corresponds to a period T10-T12, the interval R2 corresponds to a period T11-T13, the interval R3 corresponds to a period T12-T14, the interval R4 corresponds to a period T13-T15, the interval R5 corresponds to a period T15-T16, the interval R6 corresponds to a period T16-T17, and the interval R7 corresponds to a period T17-T18. In this example, the intervals R1, R2 partially overlap with each other, the intervals R2, R3 partially overlap with each other, and the intervals R3, R4 partially overlap with each other. As for such a measurable range FR, the distance may also be calculated by the phase shift TOF method as in the embodiment described above.

In the embodiment described above, the control unit 11 changes the conversion ratio of the photoelectric transducer element D10 from a value corresponding to the linear multiplication mode to a value corresponding to the Geiger multiplication mode, and vice versa. However, this is only an example and should not be construed as limiting. Alternatively, the control unit 11 may also change the conversion ratio of the photoelectric transducer element D10 between multiple values corresponding to the linear multiplication mode.

In the embodiment described above, the control unit 11 sets the conversion ratio based on various factors including the distance to the target 100, the quantity of the ambient light, the exposure duration, the quantity of the light received by the photoelectric transducer element D10 from the target 100, and the amount of the electric current flowing through the photoelectric transducer element D10. However, this is only an example and should not be construed as limiting. According to one variation, the control unit 11 may set the conversion ratio based on at least one of these various factors including the distance to the target 100, the quantity of the ambient light, the exposure duration, the quantity of the light received by the photoelectric transducer element D10 from the target 100, and the amount of the electric current flowing through the photoelectric transducer element D10.

In the embodiment described above, the conversion ratio is changed for the photoelectric transducer element D10 in all of the plurality of pixels 311 of the image sensor 31. However, this is only an example and should not be construed as limiting. According to another variation, the control unit 11 may change the conversion ratio for the photoelectric transducer element D10 in at least one pixel 311 out of the plurality of pixels 311. That is to say, the control unit 11 may change the conversion ratio(s) for only necessary one(s) of the plurality of photoelectric transducer elements D10.

Furthermore, in the embodiment described above, the photoelectric transducer element D10 is implemented as an avalanche photodiode. However, this is only an example and should not be construed as limiting. The photoelectric transducer element D10 may be any photoelectric transducer as long as the photoelectric transducer may change the conversion ratio. The photoelectric transducer element D10 may also be a photodiode of a different type from the avalanche photodiode or a solid-state mage sensor. Optionally, the photodetector unit 3 may include a plurality of photoelectric transducer elements D10 having multiple different conversion ratios. In that case, the control unit 11 may determine which one of the plurality of photoelectric transducer elements D10 should be used for each interval.

According to another variation, the distance measuring device 10 may also be implemented as a plurality of computers. For example, the functions of the distance measuring device 10 (in particular, the functions of the control unit 11 and the measuring unit 12) may also be distributed in multiple devices.

The agent that performs the function of the distance measuring device 10 described above includes a computer system. The computer system includes a processor and a memory as principal hardware components. The functions of the distance measuring device 10 according to the present disclosure may be performed by the agent by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be implemented as a single or a plurality of electronic circuits including a semiconductor integrated circuit (IC) or a large-scale integrated circuit (LSI). Optionally, a field-programmable gate array (FPGA) or an application specific integrated circuit (ASIC) to be programmed after an LSI has been fabricated or a reconfigurable logic device allowing the connections or circuit sections inside of an LSI to be reconfigured may also be used for the same purpose. Those electronic circuits may be either integrated together on a single chip or distributed on multiple chips, whichever is appropriate. Those multiple chips may be integrated together in a single device or distributed in multiple devices without limitation.

### 3. Aspects

As can be seen from the foregoing description of embodiments and their variations, the present disclosure has the following aspects. In the following description, reference signs are inserted in parentheses just for the sake of clarifying correspondence in constituent elements between the following aspects of the present disclosure and the exemplary embodiments described above.

A first aspect is implemented as a distance measuring device (10). The distance measuring device (10) according to the first aspect includes a control unit (11) and a measuring unit (12). The control unit (11) controls a photodetector unit (3). The photodetector unit (3) includes a photoelectric transducer element (D10) and an output unit (32). The photoelectric transducer element (D10) generates electrical charges on receiving light (L2) reflected from a target (100) as a part of measuring light (L1) emitted from a light-emitting unit (2). The output unit (32) outputs an electrical signal representing a quantity of the electrical charges generated by the photoelectric transducer element (D10). The measuring unit (12) calculates, in accordance with the electrical signal, a distance to the target (100) within a measurable range (FR). The control unit (11) sets, in each of a plurality of intervals (R1-R7) that form the measurable range (FR), a conversion ratio of the quantity of the electrical charges generated by the photoelectric transducer element (D10) to a quantity of the light received by the photoelectric transducer element (D10). This aspect contributes to improving the measurement accuracy over the entire measurable range (FR) of the distance to the target (100).

A second aspect is a specific implementation of the distance measuring device (10) according to the first aspect. In the second aspect, the photoelectric transducer element (D10) varies the conversion ratio according to a voltage applied thereto. The control unit (11) sets the conversion ratio by the voltage applied to the photoelectric transducer element (D10) in each of the plurality of intervals (R1-R7). This aspect facilitates setting the conversion ratio.

A third aspect is a specific implementation of the distance measuring device (10) according to the second aspect. In the third aspect, the photoelectric transducer element (D10) includes an avalanche photodiode. The conversion ratio is a multiplication factor of the avalanche photodiode. This aspect facilitates setting the conversion ratio.

A fourth aspect is a specific implementation of the distance measuring device (10) according to the second or third aspect. In the fourth aspect, the control unit (11) changes the conversion ratio according to a quantity of ambient light. This aspect may reduce the effect of ambient light on the measurement accuracy.

A fifth aspect is a specific implementation of the distance measuring device (10) according to any one of the second to fourth aspects. In the fifth aspect, the control unit (11) decreases the conversion ratio when a resolution of the distance to the target (100) is to be increased and increases the conversion ratio when the resolution is to be decreased. This aspect contributes to improving the measurement accuracy over the entire measurable range (FR) of the distance to the target (100).

A sixth aspect is a specific implementation of the distance measuring device (10) according to the fifth aspect. In the sixth aspect, the plurality of intervals (R1-R7) includes: a first interval (R1-R7); and a second interval (R1-R7) corresponding to a longer distance from the photoelectric transducer element (D10) than the first interval (R1-R7). The control unit (11) decreases the conversion ratio in the first interval (R1-R7) and increases the conversion ratio in the second interval (R1-R7). This aspect contributes to improving the measurement accuracy over the entire measurable range (FR) of the distance to the target (100).

A seventh aspect is a specific implementation of the distance measuring device (10) according to any one of the second to sixth aspects. In the seventh aspect, the control unit (11) changes, in at least one of the plurality of intervals (R1-R7), the conversion ratio according to the quantity of the light that the photoelectric transducer element (D10) has received from the target (100). This aspect contributes to improving the measurement accuracy over the entire measurable range (FR) of the distance to the target (100).

An eighth aspect is a specific implementation of the distance measuring device (10) according to any one of the second to seventh aspects. In the eighth aspect, the control unit (11) changes the conversion ratio according to an amount of an electric current flowing through the photoelectric transducer element (D10). This aspect contributes to improving the measurement accuracy over the entire measurable range (FR) of the distance to the target (100).

A ninth aspect is a specific implementation of the distance measuring device (10) according to any one of the second to eighth aspects. In the ninth aspect, the control unit (11) changes the conversion ratio according to length of an exposure duration during which the photoelectric transducer element (D10) is allowed to receive the light from the target (100). This aspect contributes to improving the measurement accuracy over the entire measurable range (FR) of the distance to the target (100).

A tenth aspect is a specific implementation of the distance measuring device (10) according to any one of the first to ninth aspects. In the tenth aspect, the plurality of intervals (R1-R7) includes: a first group including a series of intervals (R1-R7); and a second group including one or more intervals (R1-R7) different from the first group. The conversion ratio for the first group is smaller than the conversion ratio for the second group. The measuring unit (12) determines, as for the first group, the distance based on a ratio of electrical signals respectively corresponding to multiple adjacent intervals (R1-R7) selected from the series of intervals (R1-R7) included in the first group. This aspect contributes to improving the measurement accuracy over the entire measurable range (FR) of the distance to the target (100).

An eleventh aspect is a specific implementation of the distance measuring device (10) according to the tenth aspect. In the eleventh aspect, the measuring unit (12) determines, as for the second group, the distance by reference to a particular interval (R1-R7) corresponding to an electrical signal of the largest magnitude and selected from the one or more intervals (R1-R7) included in the second group. The measuring unit (12) adopts, as the distance to the target (100), a longer distance selected from the group consisting of the distance determined with respect to the first group and the distance determined with respect to the second group. This aspect contributes to improving the measurement accuracy over the entire measurable range (FR) of the distance to the target (100).

A twelfth aspect is a specific implementation of the distance measuring device (10) according to any one of the first to eleventh aspects. In the twelfth aspect, the photodetector unit (3) includes a charge storage device (C10) to store at least some of the electrical charges generated by the photoelectric transducer element (D10). The control unit (11) stores, in the charge storage device (C10) multiple times, the electrical charges generated by the photoelectric transducer element (D10). The electrical signal has a magnitude corresponding to a quantity of the electrical charges stored in the charge storage device (C10). This aspect contributes to improving the measurement accuracy over the entire measurable range (FR) of the distance to the target (100).

A thirteenth aspect is implemented as a distance measuring system (1). The distance measuring system (1) according to the thirteenth aspect includes the distance measuring device (10) according to any one of the first to twelfth aspects, the light-emitting unit (2), and the photodetector unit (3). This aspect contributes to improving the measurement accuracy over the entire measurable range (FR) of the distance to the target (100).

A fourteenth aspect is implemented as a distance measuring method. The distance measuring method according to the fourteenth aspect includes a control step and a measuring step. The control step includes controlling a photodetector unit (3). The photodetector unit (3) includes a photoelectric transducer element (D10) and an output unit (32). The photoelectric transducer element (D10) generates electrical charges on receiving light (L2) reflected from a target (100) as a part of measuring light (L1) emitted from a light-emitting unit (2). The output unit (32) outputs an electrical signal representing a quantity of the electrical charges generated by the photoelectric transducer element (D10). The measuring step includes calculating, in accordance with the electrical signal, a distance to the target (100) within a measurable range (FR). The control step includes setting, in each of a plurality of intervals (R1-R7) that form the measurable range (FR), a conversion ratio of the quantity of the electrical charges generated by the photoelectric transducer element (D10) to a quantity of the light received by the photoelectric transducer element (D10). This aspect contributes to improving the measurement accuracy over the entire measurable range (FR) of the distance to the target (100).

A fifteenth aspect is implemented as a non-transitory storage medium that stores thereon a program designed to cause one or more processors to perform the distance measuring method according to the fourteenth aspect. This aspect contributes to improving the measurement accuracy over the entire measurable range (FR) of the distance to the target (100).

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A distance measuring device comprising:
a control unit configured to control a photodetector unit, the photodetector unit including a photoelectric transducer element and an output unit, the photoelectric transducer element being configured to generate electrical charges on receiving light reflected from a target as a part of measuring light emitted from a light-emitting unit, the output unit being configured to output an electrical signal representing a quantity of the electrical charges generated by the photoelectric transducer element; and
a measuring unit configured to calculate, in accordance with the electrical signal, a distance to the target within a measurable range,
the control unit being configured to set, in each of a plurality of intervals that form the measurable range, a conversion ratio of the quantity of the electrical charges generated by the photoelectric transducer element to a quantity of the light received by the photoelectric transducer element.

2. The distance measuring device of claim 1, wherein
the photoelectric transducer element is configured to vary the conversion ratio according to a voltage applied thereto, and
the control unit is configured to set the conversion ratio by the voltage applied to the photoelectric transducer element in each of the plurality of intervals.

3. The distance measuring device of claim 2, wherein
the photoelectric transducer element includes an avalanche photodiode, and
the conversion ratio is a multiplication factor of the avalanche photodiode.

4. The distance measuring device of claim 2, wherein
the control unit is configured to change the conversion ratio according to a quantity of ambient light.

5. The distance measuring device of claim 2, wherein
the control unit is configured to decrease the conversion ratio when a resolution of the distance to the target is to be increased and increase the conversion ratio when the resolution is to be decreased.

6. The distance measuring device of claim 5, wherein
the plurality of intervals includes: a first interval; and a second interval corresponding to a longer distance from the photoelectric transducer element than the first interval, and
the control unit is configured to decrease the conversion ratio in the first interval and increase the conversion ratio in the second interval.

7. The distance measuring device of claim 2, wherein
the control unit is configured to change, in at least one of the plurality of intervals, the conversion ratio according to the quantity of the light that the photoelectric transducer element has received from the target.

8. The distance measuring device of claim 2, wherein
the control unit is configured to change the conversion ratio according to an amount of an electric current flowing through the photoelectric transducer element.

9. The distance measuring device of claim 2, wherein
the control unit is configured to change the conversion ratio according to length of an exposure duration during which the photoelectric transducer element is allowed to receive the light from the target.

10. The distance measuring device of claim 1, wherein
the plurality of intervals includes: a first group including a series of intervals; and a second group including one or more intervals different from the first group,
the conversion ratio for the first group is smaller than the conversion ratio for the second group, and
the measuring unit is configured to determine, as for the first group, the distance based on a ratio of electrical signals respectively corresponding to multiple adjacent intervals selected from the series of intervals included in the first group.

11. The distance measuring device of claim 10, wherein
the measuring unit is configured to determine, as for the second group, the distance by reference to a particular interval corresponding to an electrical signal of the largest magnitude and selected from the one or more intervals included in the second group, and
the measuring unit is configured to adopt, as the distance to the target, a longer distance selected from the group consisting of the distance determined with respect to the first group and the distance determined with respect to the second group.

12. The distance measuring device of claim 1, wherein
the photodetector unit includes a charge storage device configured to store at least some of the electrical charges generated by the photoelectric transducer element,
the control unit is configured to store, in the charge storage device multiple times, the electrical charges generated by the photoelectric transducer element, and
the electrical signal has a magnitude corresponding to a quantity of the electrical charges stored in the charge storage device.

13. A distance measuring system comprising:
the distance measuring device of claim 1;
the light-emitting unit; and
the photodetector unit.

14. A distance measuring method comprising:
a control step including controlling a photodetector unit, the photodetector unit including a photoelectric transducer element and an output unit, the photoelectric transducer element being configured to generate electrical charges on receiving light reflected from a target as a part of measuring light emitted from a light-emitting unit, the output unit being configured to output an electrical signal representing a quantity of the electrical charges generated by the photoelectric transducer element; and
a measuring step including calculating, in accordance with the electrical signal, a distance to the target within a measurable range,
the control step including setting, in each of a plurality of intervals that form the measurable range, a conversion ratio of the quantity of the electrical charges generated by the photoelectric transducer element to a quantity of the light received by the photoelectric transducer element.

15. A non-transitory storage medium that stores thereon a program designed to cause one or more processors to perform the distance measuring method of claim 14.

16. The distance measuring device of claim 3, wherein
the control unit is configured to change the conversion ratio according to a quantity of ambient light.

17. The distance measuring device of claim 3, wherein
the control unit is configured to decrease the conversion ratio when a resolution of the distance to the target is to be increased and increase the conversion ratio when the resolution is to be decreased.

18. The distance measuring device of claim 4, wherein
the control unit is configured to decrease the conversion ratio when a resolution of the distance to the target is to be increased and increase the conversion ratio when the resolution is to be decreased.

19. The distance measuring device of claim 17, wherein
the plurality of intervals includes: a first interval; and a second interval corresponding to a longer distance from the photoelectric transducer element than the first interval, and
the control unit is configured to decrease the conversion ratio in the first interval and increase the conversion ratio in the second interval.

20. The distance measuring device of claim 18, wherein
the plurality of intervals includes: a first interval; and a second interval corresponding to a longer distance from the photoelectric transducer element than the first interval, and
the control unit is configured to decrease the conversion ratio in the first interval and increase the conversion ratio in the second interval.
